(19) United States
(12) Patent Application Publication
(10) Pub. No.: US 2002/0071680 A1
(43) Pub. Date: Jun. 13, 2002

(54) Multi-reaction chamber static film processor which allows for multiple overlapped-cycle film processing

(76) Inventor: Stephen Thomas Blume, Laguna Hills, CA (US)

Correspondence Address: Stephen T. Blume DDS, 25462 Wagon Wheel C., Laguna Hills, CA, 92653, US

(21) Appl. No.: 09/732,611

(22) Filed: Dec. 11, 2000

(51) Int. Cl. G03D 3/00

(52) U.S. Cl. 396/564

(57) ABSTRACT

An automated static film processor that will allow for the running of additional processing cycles of X-ray film while a previous cycle is running, comprising a housing having a pair of chemical storage reservoirs and multiple reaction chambers. The advantage of this apparatus is that a secondary operator may start processing X-ray film immediately without having to wait for completion of a previous cycle. The reaction chambers are configured so that tubing, connectors, and valves will allow chemicals to flow into and out of each reaction chamber from a single set of developer and fixer storage reservoirs. Each reaction chamber is provided with water and drain valves, and overflow protection. Each reaction chamber includes a lid that prevents light damage while X-ray film is being processed. A drying device that forces warm air into each reaction chamber is disclosed.

### BACKGROUND OF THE INVENTION

1. Field of the Invention

The present invention relates to a type of X-ray film processor, herein called an automated static X-ray film processor, that, in order to process X-ray film, moves chemicals into and out of one of a plurality of reaction chambers. More specifically, the present invention relates to an automated static X-ray film processor that will allow for an operator to start a film processing cycle in one reaction chamber while a previous cycle has already started and is running in another.

2. Prior Art

Around 1900 radiographs were just starting to be utilized in the medical, dental, veterinary, and other health related fields. This new technology greatly aided the health practitioner in diagnosing disease and injury of the hard tissues. In more recent years, radiographs, with the aid of other diagnostic techniques, have been helpful in soft tissue diagnosis.

For over sixty years exposed radiographic film has been exclusively hand developed in a darkroom. That is, in a darkroom, the film was uncovered under protective red light, placed in developer solution, washed, placed in fixer solution, washed, and then air-dried. The deficiency of manual processing is that it is very time consuming and inefficient. In the 1970's an automated roller transport film processor was brought to market. As of this writing, roller processors are still the most common types of processor sold. This type of processor is composed of four roller racks configured one in front of the other. When x-ray film is placed in the processor, the rollers pick up the film and transport it through a series of open tanks that contain processing chemicals. X-rays are moved through developer chemical, then fixer chemical, then a water wash, and finally a dryer area. Variations have been introduced on this model. One such variation is a type of developer that uses a nylon gauze-like material configured so that it sandwiches the film, and thereby similarly transports it through the same series of tanks and chemicals as a roller processor. Other types of processors have been marketed which use other types of transport devices, all of which use a system that moves film from one end of the processor to the other. There are several inherent deficiencies with these types of transport processors that detract from their utility. Frequently, film falls out of the transport systems and becomes lost in one of the storage tanks. The result is damaged or destroyed X-ray film. Additionally, because transport mechanisms are constantly immersed in chemical, deposits collect thereon, in turn causing the film to be scratched and damaged. Transport processors require a tremendous amount of maintenance in order to remove scum that collects on the transport mechanisms. Additionally, transport processors do not process film in patient identified groups. There is no efficient way of identifying the X-rays by patient. The result is that films from one patient can be mixed up with films from another, exposing the patient to the danger of misdiagnosis. To alleviate these deficiencies, several inventors have designed and patented processors that have a single reaction chamber. Chemicals, wash water, and dryer air move into and out of this single reaction chamber. X-ray film, once placed inside, remains stationary or static therein. For the sake of this writing, this type of processor shall be designated automated static X-ray film processor. There are many advantages to this type of processor. Because film does not touch a transport device, film is not scratched, jammed, stuck together, or lost. The resultant film quality is far superior. There are no mechanisms being soaked in chemical, eliminating the need for maintenance. X-ray film is always in one location, which means the film can never be lost. Because X-ray film is batch processed, patient identity is easily accomplished. Film will not be mis-identified nor mixed up.

There are currently several patents that describe automated static film processors. Anthony R. Peres (U.S. Pat. No. 3,792,487) describes an automatic film processor system that has temperature controlled containers for storing chemicals, and he claims “a film holding chamber below”. Dennis C. Rebek (U.S. Pat. No. 4,054,902) describes an apparatus for developing photographic prints including a cabinet, which houses a developing tank. Heinrich Huss (U.S. Pat. No. 3,890,629) describes a device for developing photographic film with a tank containing a drum arranged for immersing the film in developing chemicals. Lasky and Wright (U.S. Pat. No. 4,097,884) describe an apparatus for processing X-ray film comprising a processing tank with valves for developing solutions and water. Wada and Ishikawa (U.S. Pat. No. 4,134,665) describe a single bath-type developing device. Stephen Blume (U.S. Pat. No. 5,235,372) describes developer and fixer reservoirs fluidly connected to a single reaction chamber. Theodore Perl (U.S. Pat. No. 3,727,533) describes a small X-ray developer where films are dropped into a developing tank. M. Mastrosimone et al (U.S. Pat. No. 3,437,030) claims a processor with a container and a means to move developer chemicals into and out of said container.

The key deficiency of static film processors is the fact that it is not possible for an operator to begin processing a second set of film once a previous set has been started and is still running. Because of this fact, static film processors are ergonomically very inefficient. The operator must wait until the first set of X-ray film is completed before a second set can be placed inside for processing.

In order to alleviate this deficiency, Blume Imaging, a California LLC, manufactured and sold a static film processor with a horizontal rotating lid. X-ray film was placed on a cassette, then attached to the lid via an attachment device. When the start key was pressed, the lid would rotate 180 degrees, moving the X-ray film down into the reaction chamber. A new upper vacant side was now available for a second set of X-ray film to be attached. A second operator would place film on a cassette, then attach the cassette to the upper lid surface via an attachment device. The X-ray film in the reaction chamber is developed, washed, then dried. Once the cycle was complete, the lid would rotate the completed film up, and the second film set down into the reaction chamber for processing. Once the completed first cycle film was removed from the lid, the now vacant upper lid would be ready for another set of exposed X-film to be attached. This early solution to the second cycle deficiency of automated static X-ray film processors proved successful, but required complex mechanics and electronics, raising the per unit cost of the processor. Assembly was also complicated. Additionally, the radius required to rotate the film into the reaction chamber made the outer dimensions of the processor quite large, which proved to be another deficiency. Further, cycles run consecutively rather than successive but overlapped. That is, a secondary cycle cannot run while a primary cycle is running. The result is that this design is “time inefficient.” Two seven-minute cycles would take at least fourteen minutes to process.

DXSS Inc., a company from the state of Washington, produced a static film processor with a single reaction chamber and a “waiting” black box which serves as a holding station for the next film group. If a first set of X-ray film is already processing, a second operator may uncover previously exposed film and place it in the black box with lid. This black box is light proof, and will not allow film to be damaged. A flashing indicator light shows that X-ray film is inside, ready for processing. When a first operator removes completed film from a first cycle, that first operator will place the film from the black box in the processor, and start a another developing cycle, thus producing a “pseudo” second cycle. This solution is simple, but time consuming and inefficient. Because cycles run consecutively, a second cycle may not be completed for over fifteen minutes, interrupting the ergonomic flow of the facility. And, the possibility of error by a second operator handling the exposed film, or neglecting to place the black box film in the processor further complicates matters. The DXSS design has its own set of deficiencies. Clearly, there must be an improvement in the design of static film processors. No static processor design is known that will simply and efficiently allow the running of a second cycle while a first cycle has already started. Transport processors allow operators to continually feed film in making transport processors more ergonomically efficient. Without such an improvement, automated static film processors cannot be commercially successful.

### SUMMARY OF THE INVENTION

In accordance with a preferred embodiment of the present invention there is provided a plurality of X-ray film cassettes which hold the film during manipulation, and an automated static X-ray film processor comprising a housing defining first and second reservoirs which are capable of storing quantities of developer and fixative agents therein. The housing further includes two or more reaction chambers, each defining a front, back, and side walls, a lower surface, and an upper rim with lid. The lid is capable of being open when film is being inserted or removed from the reaction chamber, and closed to prevent light damage to X-ray film once film processing has begun. Each reaction chamber is sized and configured to receive a plurality of X-ray film cassettes with intra-oral film. Further, each reaction chamber is sized to receive cassettes that hold panographic (12″×6″) and cephalometric (8″×10″) extra-oral film combined with intra-oral X-ray film as required. The reaction chambers and reservoirs are to be constructed of a chemically inert material such as plastic, stainless steel, or the like, to prevent severe corrosion that would be caused by developer and fixer chemicals, and are fluidly sealed to hold a quantity of water and chemcal.

The first and second reservoirs communicate via respective feed lines or conduits to each reaction chamber, thereby allowing the flow of chemicals between the first and second reservoirs and reaction chambers. Disposed between each feed line and reaction chamber is a manifold with valves utilized for the organized and sequential flow of water and chemicals into and out of the reaction chambers. Each manifold has mounted thereon developer, fixer, and drain valves. The developer and fixer valves are operable to selectively place a respective reservoir in fluid communication with each of the reaction chambers. Preferably, each of the feed lines with manifold and valves connecting the reservoirs to each reaction chamber are fluidly coupled to a point adjacent to the lower surface of the reaction chambers. Fluidly coupled to and extending from each reaction chamber manifold adjacent to the lower surface thereof is a drain line, which includes a drain valve coupled therein for selectively opening and closing each drain line. Each reaction chamber manifold further includes one or more water filler hoses fluidly coupled thereto which are connected to an incoming water source and used to selectively fill each reaction chamber with water, thereby rinsing the X-ray film.

Additionally, each feed line is configured so that it is in communication with a selected first force means which is capable of moving chemical from the first and second reservoirs into each reaction chamber. The first force means may be a pump, air pressure, gravitational force, vacuum, or the like. Further, each feed line is configured so that it is in communication with a selected second force means, which is capable, of moving chemical back into the reservoirs. The second force means may be a pump, air pressure, gravitational force, vacuum, or the like.

Also, fluidly coupled to each reaction chamber adjacent to the upper rim is an overflow line configured to prevent flooding if a malfunction of the water or chemical valves occurs. The overflow pipe should have large enough lumen to contain liquids and prevent overflowing for a long period of time should there be a valve failure. Additionally, each reaction chamber includes a hose disposed to allow the inflow of warm air from a heater/blower mechanism for the purpose of drying film once a final wash cycle is completed.

In accordance with the preferred embodiment, the front walls of the reaction chambers are oriented in a manner complimentary to the shape of the X-ray film cassettes and/or larger X-ray film rack. Additionally, the distance separating the front and back walls of the reaction chambers (i.e., the width of the side walls) is dimensioned so as to slightly exceed the width of the film holding cassettes and film, and no more, the purpose being to utilize the least amount of chemical possible. Further, the height of the reaction chambers should be just enough to allow a thorough submerging of the X-ray film (½ to 1 inch) plus an additional height that will resist the overflow of chemicals or water. Further, the height of the reaction chamber should be sufficient to allow for the placement the overflow pipe above the maximum height of the water level in the reaction chamber. X-ray film cassettes and large film holders are configured to be attachable or supportable by the rim of each reaction chamber so that the film does not touch the chamber bottom or sides during processing. In this respect the upper part of the film holding cassettes and large film holder is supported by the upper rim of the reaction chambers so that film will be totally immersed in chemistry solutions sequentially applied therein.

In operation of the automated static X-ray film processor of the present invention, a primary operator exposes X-ray film on the patient in an operatory. The exposed X-ray films are taken to a darkroom or placed in a daylight loading device attached to the processor where they are uncovered then mounted on a film holding device or cassette, then placed in an available reaction chamber. The lid of the reaction chamber is closed, and the start key for that chamber is pressed on an electronic controller panel. As soon as the developing cycle commences in the primary reaction chamber, a secondary operator who has already exposed film on another patient may now uncover the film and place it in an available secondary reaction chamber, and press the associated start key. The second set of film will remain in waiting in the secondary reaction chamber until the fixer chemical portion of the cycle in the primary chamber is complete, making chemicals available for the secondary cycle. The secondary cycle will commence in the secondary reaction chamber as soon as the fixer chemical is returned to the fixer reservoir from the primary reaction chamber. Or, if the fixer portion of the primary cycle is complete and X-ray film in the first reaction chamber is in final washing and drying, the secondary cycle may start immediately in the secondary reaction chamber.

In the preferred embodiment, the developing cycle in the primary reaction chamber proceeds as follows: the valve disposed between the developer reservoir and the primary reaction chamber is electronically opened and first force means is activated which forces developer chemical to flow into the primary reaction chamber and begin the developing process. Once the X-ray film is properly developed, developer chemical is returned to the developer reservoir via second force means. The associated developer valve is closed, trapping the developer chemical therein. A water wash is then initiated electronically, by operating the water valve associated with the primary reaction chamber which fills the primary reaction chamber with water. Water inflow is terminated when it reaches a water sensor in close proximity to the top of the primary reaction chamber. The water sensor is configured above the highest level that chemicals reach to insure a thorough removal of remnant chemical. Additionally, the water sensor is configured so that the X-ray films therein are thoroughly submerged with water so that a complete wash is accomplished. Once water touches the water sensor, the associated primary reaction chamber water valve is electronically closed and the associated drain valve is electronically opened. Wash water is thereby drained from the primary reaction chamber. Once all wash water is removed from the reaction chamber, the drain valve is closed. Next, the valve disposed between the fixer reservoir and the primary reaction chamber is electronically opened and a first force means is activated which forces fixer chemical to flow into the primary reaction chamber and begin the fixing process. Once the X-ray film is properly fixed, the fixer chemical is returned to the fixer reservoir via second force means and the associated valve is closed, trapping the fixer chemical therein. At this time in the primary cycle, chemicals are available for use in the secondary reaction chamber, and a processing cycle in the secondary reaction chamber may commence.

X-ray film in the primary reaction chamber is now washed, as described above. A drying function now commences, whereat warm air is blown on the X-ray film from a blower and heater coil mechanism. Once the X-ray film is dried, the primary processing cycle is completed. The X-ray film is removed from the primary reaction chamber, another set of exposed film may be placed therein, and another developing cycle begun while X-ray film is processing in the secondary reaction chamber; and on and on. Processing proceeds in the secondary reaction chamber in the same manner as described above for the primary reaction chamber.

### BRIEF DESCRIPTION OF THE DRAWINGS

These as well as other features of the present invention will become more apparent upon reference to the drawings wherein:

FIG. 1 is a front perspective view of the automated static X-ray film processor with chassis cover.

FIG. 2 is a schematic diagram of workings of the present invention.

FIG. 3 is a schematic diagram showing how the present invention would be configured if there were more than two reaction chambers.

FIG. 4 is an uncovered perspective view of the preferred embodiment showing reaction chambers and chemical storage reservoirs.

FIG. 5a, 5b, and 5c are side views showing chemical moving from the developer reservoir to primary and secondary reaction chambers in separate cycles.

FIG. 6a and b are the showing of a manifold of the preferred embodiment.

FIG. 7 and FIG. 8 are schematic diagrams of how the cycles would operate in each reaction chamber of the present invention.

### DETAILED DESCRIPTION OF THE PREFERRED EMBODIMENT

Refer now to the drawings wherein the showings are for the purposes of illustrating a preferred embodiment of the present invention only and not for the purposes of limiting the same.

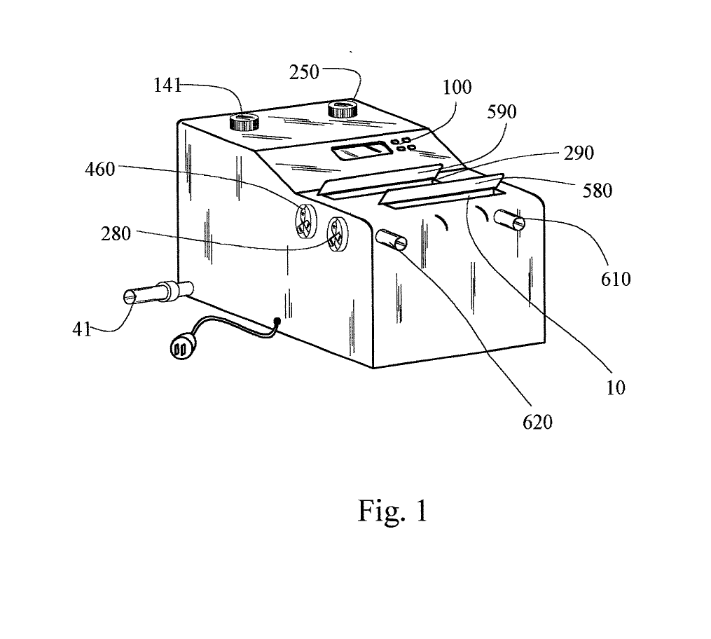

Refer to FIG. 1, which is a front view of the automated static X-ray film processor with chassis cover. Reaction chambers A (10) and B (290) have lids (580) and (590) respectively, which provide light protection during processing cycles. Overflow pipes (610) and (620) are configured so that if water valve or chemical valve malfunctions occur, liquid will drain down said overflow pipes rather than flooding the processor and/or countertop. Control panel (100) is utilized by the operator to start and monitor processing cycles. Drain pipe (41) is the confluence of drain pipes emanating from each reaction chamber. Heater blowers and inlets (280) and (460) are configured to dry film within said reaction chambers A and B.

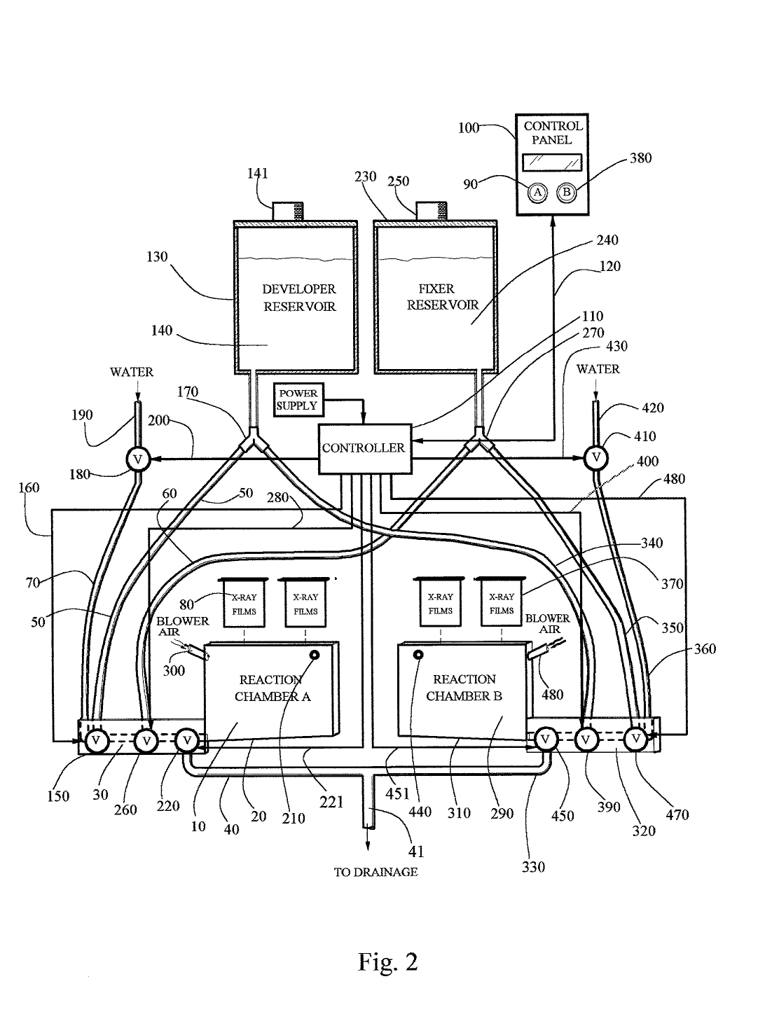

Now refer to FIG. 2 for a detailed description of the operation of the automated static X-ray processor. In FIG. 2 there is configured one developer chemical reservoir (130), one fixer chemical reservoir (230), and reaction chambers (10) and (290). Chemicals will move from the storage reservoirs to the reaction chambers and back in previously determined orderly and timed cycles so that X-ray film within said reaction chambers will be properly processed. A variety of force means may be utilized to accomplish this fluid movement such as pump, vacuum, gravity, air pressure, or the like. For the purpose of this writing, force means that forces chemical into said reaction chambers shall be denoted first force means. Force means that returns chemical to said developer and fixer reservoir shall be denoted second force means.

In FIG. 2, there is configured a reaction chamber A (10) sized to accept the placement within of various sizes of X-ray film with holders. Said reaction chamber A comprises a front, back, and two side walls, and a bottom section having a drain slope (20) so that liquid within can flow toward manifold A (30). Manifold A acts as the confluence of drain valve A (220) and hose (40), developer valve A (150) and hose (50), fixer valve A (260) and hose (60), and water hose (70). Manifold A is further configured so that the opening of any of the valves individually will allow the free flow of water, developer, or fixer chemical into and out of reaction chamber A without affecting or being affected by the remaining closed valves and liquids. To start a primary developing cycle in reaction chamber A (10), a primary operator uncovers previously exposed X-ray film in a darkroom or daylight loading device, places said X-ray film on a film holding cassette, then places said X-ray film with holder (80) in said reaction chamber A (10). The primary operator then presses key A (90) on control panel (100). Control panel (100) is electronically coupled with controller (110) via cable (120). An electronic signal is sent to controller (110) via cable (120), which starts the developing cycle in reaction chamber A. At this time, a secondary operator may place X-ray film in reaction chamber B, and press start key B (380). Said X-ray film will remain in waiting in said reaction chamber B until chemicals are available from said primary cycle in reaction chamber A.

There is configured a developer reservoir (130) with a front, back, two sides, bottom, and a top, fluidly sealed, with developer solution (140) inside. Said developer reservoir is further configured with a means for filling and removing chemical, a lid (141) or the like. Said developer reservoir is fluidly connected to developer valve A (150) through hose (50). Once start key A (90) has been pressed, an electronic signal is sent to controller (110) which in turn signals, via cable (160), developer valve A (150) to open and first force means to function. Developer chemical (140) flows through wye (170), hose (50), manifold (30), developer valve A (150) and into reaction chamber A (10). Flow of developer chemical into said reaction chamber A will continue until said X-ray film is well submerged with solution. X-ray film and cassette (80) is bathed in developer chemical for a designated period of time. An image is now formed on said X-ray film which is still sensitive to and can be damaged by light. Second force means is next activated by controller (110) so that said developer chemical flows from reaction chamber A (10) back into developer reservoir (130) via hose (50), and wye (170). When all developer chemical is returned to developer reservoir (130), controller (110) electronically closes valve (150) and terminates second force means, sealing said developer chemical in said developer reservoir. At this time, the developer portion of the primary cycle in reaction chamber A is complete.

A water wash of reaction chamber A is now initiated. In the preferred embodiment, water valve A (180) is connected to an external water source by hose (190) and is fluidly connected to manifold A by hose (70). Controller (110) sends a signal via cable (200) to water valve A (180), which opens said water valve A and causes water to flow into reaction chamber A (10). Said reaction chamber A is configured with water sensor A (210) positioned so that it is adjacent to the upper rim and above the highest level of the chemicals that flow therein. Water sensor A (210) is electronically coupled to controller (110). When wash water from water valve A (180) reaches water sensor A (210), a signal is sent to controller (110), which causes water valve A (180) to shut off.

Controller (110) now opens drain valve A (220) via electronic coupler (221), causing water to drain through manifold A (30), drain valve A (220), and drain hose (40) to external drainage. The purpose of the wash cycle is to remove all chemical residue from said X-ray film (80) and said reaction chamber A, thereby stopping the fixing of said X-ray film. Additionally, cross contamination of developer and fixer chemicals is prevented by a thorough washing of said reaction chamber A. Once reaction chamber A (10) has been thoroughly washed, as described above, and drain valve A (220) has been closed by an electronic signal from controller (110), it is now ready for the fixer portion of said primary cycle.

There is configured fixer reservoir (230) comprising a front, back, two sides, a bottom, and a top, fluidly sealed, filled with a quantity of fixer solution (240). Said fixer reservoir is further provided with a means for adding and removing chemical, a lid (250) or the like. Said fixer reservoir is fluidly coupled to said reaction chamber A via manifold A (30), fixer valve A (260) hose (60), and wye (270). Fixer valve A (260) is electronically coupled to controller (110) via cable (280). Controller (110) now signals fixer valve A (260) to open via cable (280), and first force means to activate, causing fixer chemical (240) to flow through wye (270), hose (60), manifold A (30) and into reaction chamber A (10). Flow of said fixer chemical continues until the inserted X-ray film on cassette (80) is completely submerged. Fixer chemical converts the image on said X-ray film previously bathed in developer chemical into a negative, and permanently fixes the image so that it may not be damaged by light. Fixer chemical remains in reaction chamber A (10) until said X-ray film is completely fixed. Second force means is then activated by controller (110) so that said fixer chemical will flow from reaction chamber A (10) back into fixer reservoir (230) via hose (60), and wye (270). When all fixer chemical is returned to fixer reservoir (230), controller (110) causes the closure of fixer valve A (260) and terminates second force means, sealing said fixer within said fixer reservoir (230). The chemical portion of the primary cycle in reaction chamber A is now complete. In the preferred embodiment, at this time in the primary cycle, developer and fixer chemicals are available to start a secondary cycle in reaction chamber B (290). Said X-ray film previously placed in reaction chamber B may now commence processing while washing and drying are accomplished in reaction chamber A.

To finish the processing cycle in reaction chamber A, X-ray film (80) is water washed as described above. Warm air from a heater/blower mechanism is next directed at said X-ray film through blower air vent A (300) which accomplishes drying. Once dry, said X-ray film is ready for removal, mounting, and diagnosis. Reaction chamber A (10) is now available to process another set of film.

There is configured reaction chamber B (290), sized to accept the placement within of various sizes of X-ray film with holders. Said reaction chamber B (290) comprises a front, back, and two side walls, and a bottom section having a drain slope (310) so that liquid within can flow toward drain manifold B (320). Mountings, within the automated static film processor, of reaction chamber A (10) and reaction chamber B (290) are offset horizontally and configured so that there is room for hoses, manifolds, and other needed plumbing to be attached to the drain opening of each chamber. Manifold B (320) acts as the confluence of drain valve B (450) and its hose (330), developer valve B (390) and its hose (340), fixer valve B (470) and its hose (350), and water hose (360). Manifold B is further configured so that the opening of any of the valves individually will allow the free flow of water or developer or fixer chemical into and out of reaction chamber B without affecting or being affected by the remaining non-operative valves and liquids.

To start a secondary developing cycle in reaction chamber B (290), a secondary operator has placed previously exposed and uncovered X-ray film (370) within, and pressed key B (380) on control panel (100) during the processing of X-ray film in reaction chamber A. Once chemical are available in the processing in reaction chamber A (10), an electronic signal is sent to controller (110) via cable (120) which initiates said secondary developing cycle in said reaction chamber B. Controller (110) now signals developer valve B (390) to open via cable (400), and first force means to activate. Developer chemical flows through wye (170), hose (340), manifold B (320), and into reaction chamber B (290). X-ray film may be placed in reaction chamber A (10) and start key A (90) pressed at this time if film in said reaction chamber A has completed processing and is removed. Flow of developer chemical (140) into reaction chamber B (290) will continue until said X-ray film within is well submerged with solution. X-ray film (370) is bathed in developer chemical for a designated period of time. An image is now formed on said X-ray film, which is still sensitive to and can be damaged by light. Once the developer stage of said secondary cycle is completed, said second force means is activated electronically by controller (110), forcing developer solution to flow back into developer reservoir (230). When all developer chemical (140) is returned to developer reservoir (130), controller (110) acts to close developer valve B (390) and terminate second force means, sealing said developer in said developer storage reservoir (230).

A water wash of reaction tank B is now begun. In the preferred embodiment, water valve B (410) is connected to an external water source via hose (420). Controller (110) sends a signal via cable (430) to water valve B (410), which causes water to flow into reaction chamber B (290). Said reaction chamber B is configured with water sensor B (440) adjacent to the upper rim, and positioned so that it is above the highest level of the chemicals that flow therein. Water sensor B (440) is electronically coupled to controller (110). When wash water from water valve B (410) reaches water sensor B (440), a signal is sent to controller (110), which causes said water valve B to shut off. Controller (110) now electronically opens drain valve B (450) via electronic coupler (451), causing water to drain through manifold B (320), drain valve B (450), and drain hose (330), to combined drain hose (41), to external drainage. Once said reaction chamber B and X-ray film has been thoroughly washed, as described above, it is now ready for the fixer portion of said secondary cycle.

Fixer reservoir (230) is fluidly connected to said reaction chamber B by manifold (320), fixer valve B (470), hose (350) and through wye (270). Fixer valve B (470) is electronically coupled to controller (110) via cable (480). Controller (110) signals said fixer valve B to open and first force means to activate via cable (480), causing fixer chemical (240) to flow through wye (270), hose (350), manifold B (320) and into reaction chamber B (290). Flow of fixer chemical continues until said X-ray film therein is completely submerged. Fixer chemical turns the image on film previously bathed in developer chemical into a negative, and permanently fixes the image so that it may not now be damaged by light. Fixer chemical remains in reaction chamber B (290) for a designated period of time. Once fixing has been completed, second force means is now activated by controller (110) so that said fixer chemical will flow from reaction chamber B (290) back into fixer storage tank (230). Fixer valve B (470) is then electronically closed via controller (110), trapping fixer chemical therein. X-ray film may now commence processing in reaction chamber A while said secondary cycle in reaction chamber B is continuing. In this fashion, cycles may continually be run in overlapping succession, alternating between chambers A and B. A wash cycle next commences in reaction chamber B as described above. Controller (110) then operates an heater blower mechanism, forcing hot air through inlet (480), which dries said X-ray film. Said X-ray film is now removed from reaction chamber B, making reaction chamber B available for a new processing cycle.

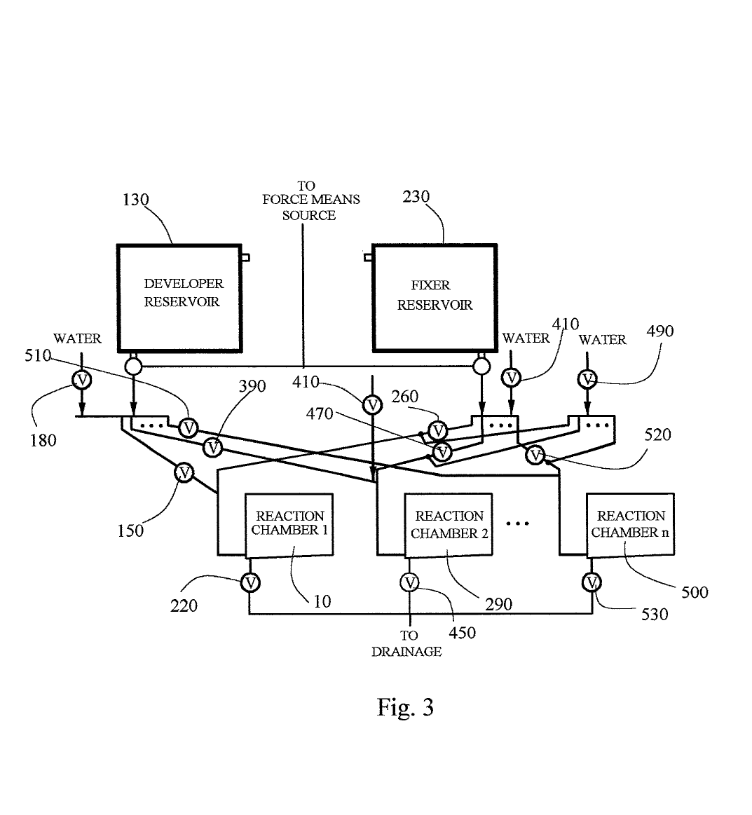

Now refer to FIG. 3, which demonstrates that more than two reaction chambers may be utilized with this design. In this drawing, reaction chambers A and B will be denoted reaction chambers 1 and 2 respectively. Additional chambers shall be denoted with the single letter n. As shown in previous drawings, there is provided developer storage reservoir (130) and fixer reservoir (230). Said developer reservoir is fluidly coupled to reaction chamber 1 (10), by developer valve A (150) and its hose. Said fixer reservoir (230) is fluidly coupled to reaction chamber 1 (10) by fixer valve A (260) and its hose. Further, developer reservoir (130) is fluidly coupled to reaction chamber 2 (450) by developer valve B (390) and its hose. Fixer reservoir (230) is fluidly coupled to said reaction chamber 2 by fixer valve B (470) and its hose. Further, there is provided reaction chambers n (500). The letter n represents the number of additional reaction chambers more than the two previously disclosed in this system. Manufacturing an automated static X-ray film processor with three or more reaction chambers will allow for the processing of additional cycles, making said processor even more ergonomically efficient. Said reaction chambers n (500) are fluidly connected to developer reservoir (130) through developer valve n (510) and its hose. Additionally reaction chambers n (500) are fluidly connected to fixer reservoir (230) through fixer valves n (520) and its hose. Water valve (180) supplies reaction chamber 1, water valve (410) supplies reaction chamber 2, and water valves n (490) supplies reaction chambers n. Said water valves (180), (410), and (490) are connected to an external water source, and when activated will wash their respective reaction chambers. Wash water will drain through drain valves A (220) for reaction chamber 1, drain valve B (450) for reaction chamber 2, and drain valves n (530) for reaction chambers n. Each reaction chamber will have its own heater/blower mechanism which will dry processed X-ray film.

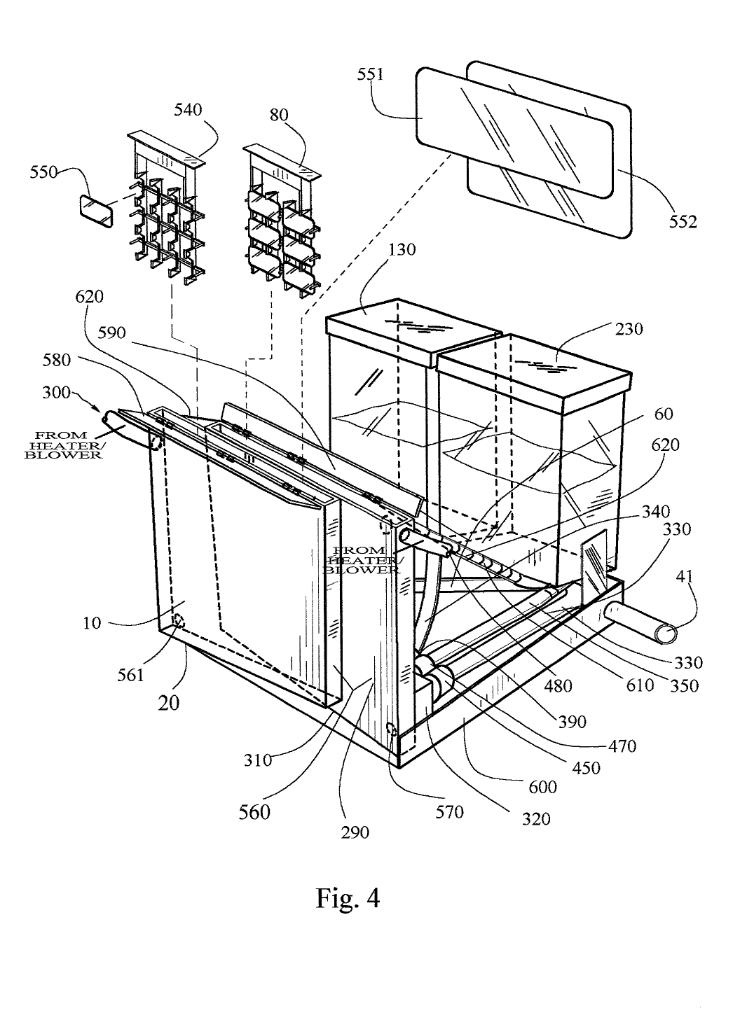

Now refer to FIG. 4, which demonstrates how the chemical reservoirs and reaction chambers are configured and film is placed into processor reaction chambers. In the preferred embodiment, there is provided film cassette (540), configured to hold previously exposed X-ray film (550). Reaction chambers A (10) and B (290) are sized and configured to hold enough X-ray film cassettes so that 18 to 24 dental intra-oral films may be processed in each cycle which would constitute a full mouth film series. In the preferred embodiment, reaction chamber A (10) and reaction chamber B (290) are sized and configured to hold three six to eight-film cassettes each, totaling eighteen to twenty-four 24 intra-oral dental films. Additionally, said reaction chambers A and B are also sized to hold extra-oral film of sizes 12″×6″ (551), and 8″×10″ (552). In the case of medical film processing, said reaction chambers may also be sized to hold any size X-ray film desired by the user.

In the preferred embodiment, said reaction chambers A and B are offset (560), which allows tubing, valves, and a manifolds to be attached to the lower backsides where they are accessible to the drain and to storage reservoirs. Said reaction chambers A and B bottoms are configured at an angle (20) and (310) so that liquid inside will flow to drain openings (561) and (570) respectively. In the preferred embodiment, reaction chamber A (10) drains to the left, and reaction chamber B (290) drains to the right, the purpose being to keep the manifold, tubing, and plumbing separated.

In a darkroom or daylight loader, a first operator uncovers and places previously exposed film (550) on film cassette (540). Said film cassettes are then placed in reaction chamber A (10) for processing. Reaction chamber A lid (580) is then closed to keep said X-ray film from being light exposed during processing. Start key A on the control panel is pressed which starts the processing cycle in said reaction chamber A. Once the X-ray film in said reaction chamber A is processing, a secondary operator will be able to place film in reaction chamber B (290) in the same manner. Reaction chamber B lid (590) is then closed and start key B on the control panel is pressed. Film can then be processed in both chambers at the same time, of course reaction chamber A cycle would be ahead of reaction chamber B. Once reaction chamber A film is finished, that chamber will now be available for another set of film. Also shown in FIG. 4 are developer reservoir (130) and fixer reservoir (230), and processor base (600). Additionally, reaction tanks A and B are provided with overflow pipes (610) and (620) which will prevent flooding in case of malfunction of the water or chemical valves.

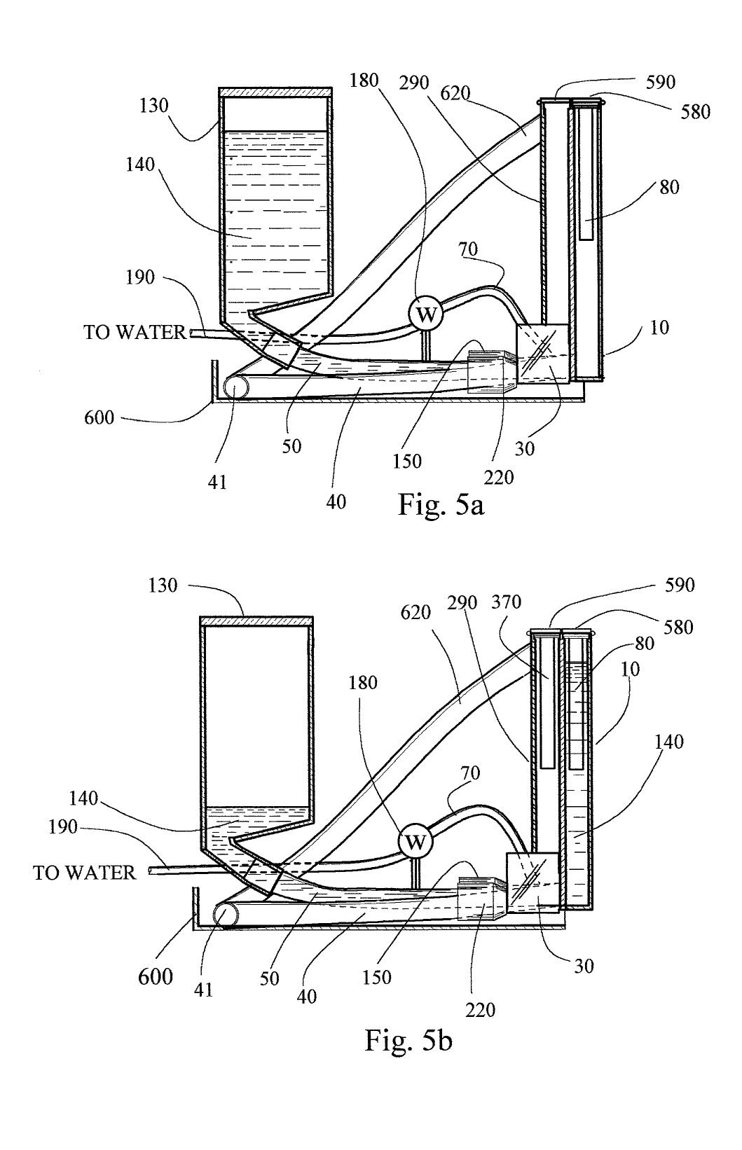

Refer now to FIGS. 5a, 5b, and 5c which demonstrate how, in the preferred embodiment, developing solutions flow into and out of reaction chambers during a primary and secondary cycle. For clarity, only the left side of the preferred embodiment is shown. Referring to FIG. 5a, there is provided developer reservoir (130) filled with developer chemical (140). Said developer reservoir is fluidly coupled to reaction chamber A (10) via manifold (30), developer valve B (150), and its hose (50). A primary operator, in a darkroom or daylight loader, uncovers previously exposed X-ray film, then places said X-ray film on cassette (80). Said film with cassette is placed in reaction chamber A (10). Reaction chamber A lid (580) is closed. The operator then presses start key A on the control panel. A processing cycle commences with the opening of developer valve A (150) and activation of first force means. Developer chemical (140) flows into said reaction chamber A.

Now, referring to FIG. 5b, developer solution (140) has filled reaction chamber A (10) via first force means. Flow will continue into said reaction chamber A until film therein is completely submerged in solution. Once the developer portion of the cycle is completed, developer solution is returned to said developer reservoir by activation of second force means. As soon as all developer solution is in developer reservoir (130), said developer valve A is closed, trapping all developer solution within, as shown in FIG. 5a.

Following the fixer portion of said the primary cycle, developer chemicals are available for use in reaction chamber B. A secondary operator uncovers previously exposed X-ray film and places said X-ray film on cassette (370). Said cassette with film is placed into said reaction chamber B, and lid (590) is closed. The secondary operator then presses start key B on control panel (60) which begins a secondary cycle in reaction chamber B. Said secondary cycle runs while said primary cycle in reaction chamber A is continuing. Referring to FIG. 5c, film in reaction chamber A is being washed with wash water (141) from water valve (180), as film in reaction chamber B is developing. Liquid shown in reaction chamber B (290) is developer chemical (140) from developer reservoir (130). After a wash cycle, fixer chemical is flowed into reaction chamber B (290) in the same manner, and then film is again washed and then dried. Once processed X-ray film in reaction chamber A (10) is removed, said reaction chamber A is ready for another set of film. Said secondary cycle in reaction chamber B continues on to completion; and on and on.

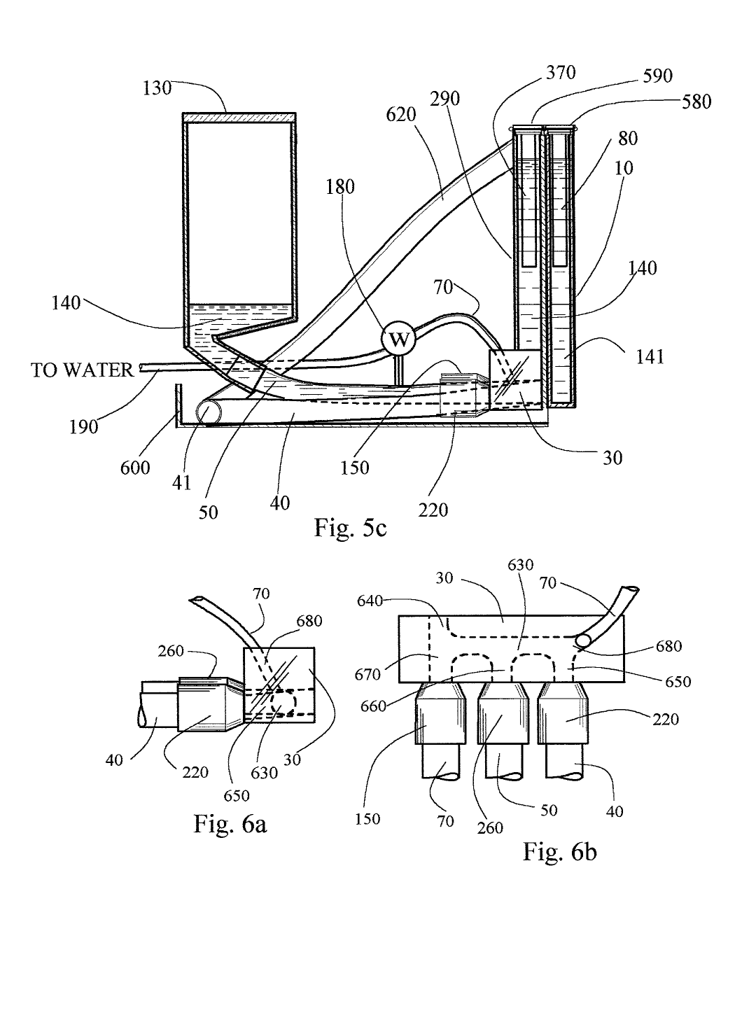

Now refer to FIG. 6a and b, included for the showing of how, in the preferred embodiment, the manifold is configured. In FIG. 6a, a side view of block manifold (30) is shown. Drain aperture (650) allows water to flow toward drain valve (220) and to drain hose (40). Note the downward orientation of said drain aperture, which allows for the flow of liquid into drain hose (40). Water aperture (680) is fed by water hose (70) and is configured so that wash water will flow into all internal areas of said manifold. FIG. 6b shows apertures into all valves from the drain of reaction chamber A. In the preferred embodiment, main manifold aperture (640) of manifold (30) is lined up exactly with the its corresponding drain aperture of reaction chamber A. A mirror image manifold would of course be utilized for reaction chamber B. Drain aperture (650) fluidly couples drain valve A (220) with the reaction chamber drain aperture through manifold apertures (630) and (640). Manifold aperture (660) fluidly couples fixer valve A (260) with said reaction chamber A drain aperture through manifold apertures (630) and (640). Manifold aperture (670) fluidly couples developer valve A (150) with said reaction chamber A through said developer valve manifold apertures (630) and (640).

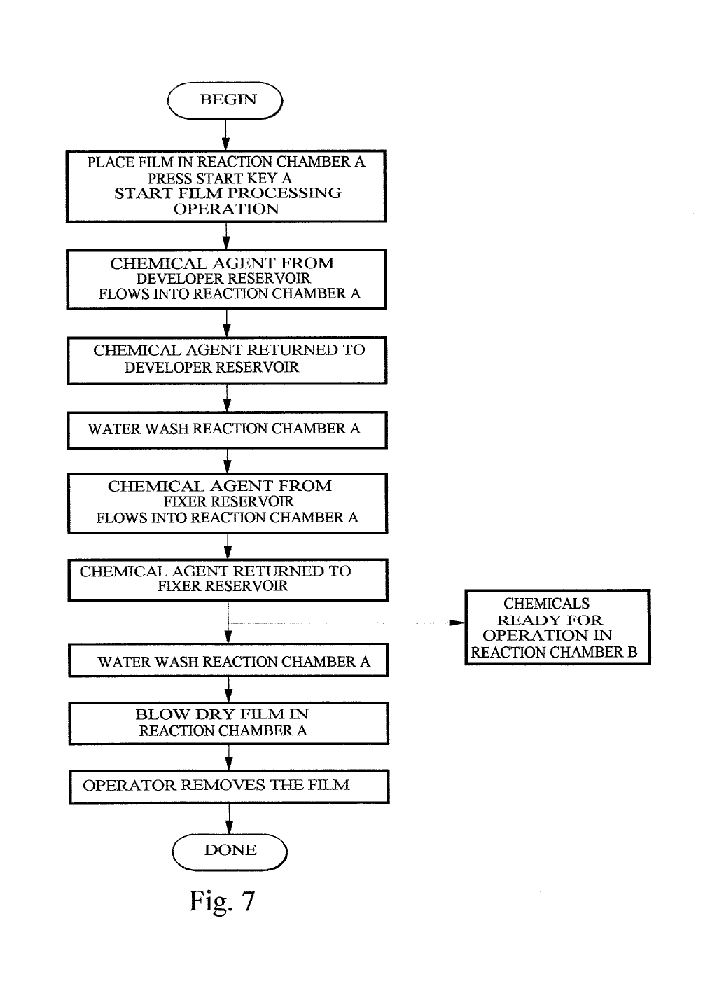

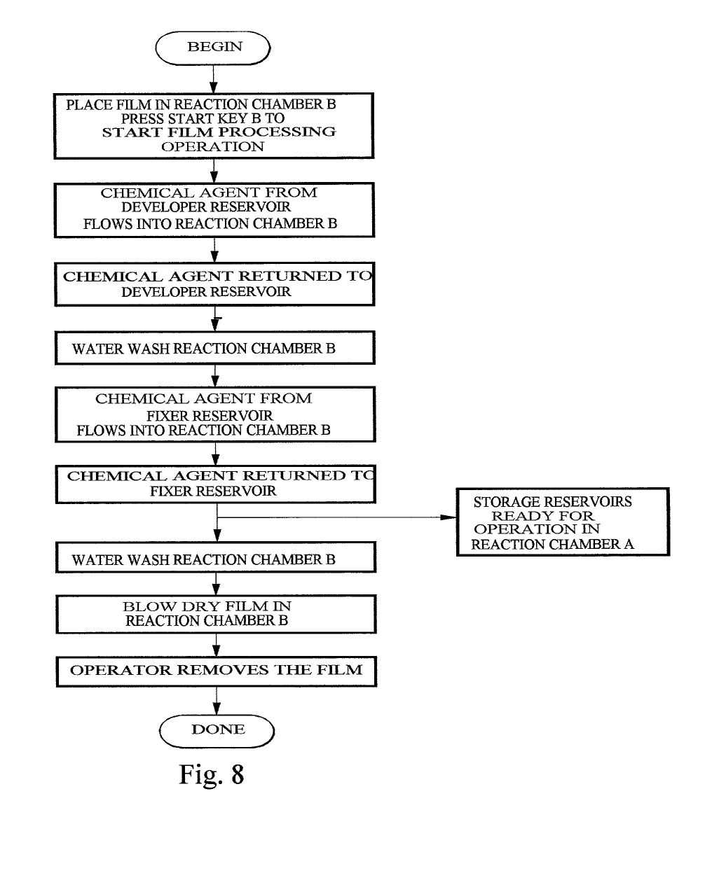

Now, refer to FIG. 7 and 8, which are block diagrams showing how processing cycles function, and when chemicals will be available for a secondary processing cycle when films are cycling in a primary reaction chamber. FIG. 7 displays the developing cycle in reaction chamber A. Note that chemicals will be available for use in reaction chamber B after fixer chemical is returned to the fixer reservoir from reaction chamber A.

Additionally, when film is processing in reaction chamber B, chemicals will be available for use in reaction chamber A after fixer chemical is returned to the fixer reservoir from said reaction chamber B, as shown in FIG. 8.

Additional modifications and improvements of the present invention may also be apparent to those skilled in the art. Thus, the particular combination of parts described and illustrated herein are intended to represent only one embodiment of the invention and is not intended to serve as limitations of alternative devices within the spirit and scope of the invention.

What is claimed is:

1. An automated static X-ray film processor which holds film being processed in a reaction chamber in an immobile state while chemicals, water, and dryer air move in and out of said reaction chamber, that allows additional processing cycles to run while a previous cycle is running, comprising:
A. a first storage reservoir for storing a quantity of a developer agent;
B. a second storage reservoir for storing a quantity of a fixative agent;
C. a first reaction chamber sized and configured to receive at least one previously exposed X-ray film and holder, said reaction chamber defining a front, back, and two side walls, an upper rim, and lower surface, positioned so that it can accept a feed line from said first reservoir, second reservoir, and external drain;
D. a second reaction chamber, sized and configured to receive at least one previously exposed X-ray film and holder, said reaction chamber defining a front, back, and two side walls, an upper rim, and lower surface, positioned so that it can accept a feed line from said first reservoir, second reservoir, and external drain;
E. an n reaction chamber, the letter n representing all numbers of reaction chambers more than two required to run n+2 successive overlapping cycles, said n reaction chambers each sized and configured to receive at least one previously exposed X-ray film and holder, said reaction chambers each defining a front, back, and two side walls, an upper rim, and lower surface, positioned so that they can each accept a feed line from said first reservoir, second reservoir, and external drain;
F. a first feed line and valve electronically coupled therein for selectively opening and closing said first valve and feed line, connecting said first reservoir to said first reaction chamber, placing said reaction chamber in fluid communication with the developer agent stored within said first reservoir;
G. a second feed line and valve electronically coupled therein for selectively opening and closing said second valve and feed line, connecting said first reservoir to said second reaction chamber, placing said second reaction chamber in fluid communication with the developer agent stored within said first reservoir;
H. a third feed line and valve electronically coupled therein for selectively opening and closing said valve and feed line, connecting said second reservoir to said first reaction chamber, placing said first reaction chamber in fluid communication with the fixer agent stored within said second reservoir;
I. a fourth feed line and valve electronically coupled therein for selectively opening and closing said fourth valve and feed line, connecting said second reservoir to said second reaction chamber, placing said second reaction chamber in fluid communication with the fixer agent stored within said second reservoir;
J. feed lines and valves as needed, electronically coupled therein for selectively opening and closing said valves and feed lines, connecting said first reservoir to said n reaction chamber, placing said n reaction chamber in fluid communication with the developer agent stored within said first reservoir;
K. feed lines and valves as needed, coupled therein for selectively opening and closing said valves and feed lines, connecting said second reservoir to said n reaction chamber, placing said n reaction chamber in fluid communication with the fixer agent stored within said second reservoir;
L. at least one water line per reaction chamber, connected to a water source via a water valve, and fluidly coupled to each said reaction chamber;
M. at least one drain line fluidly coupled to and extending from each said reaction chamber, each said drain line including a drain valve electronically coupled therein for selectively opening and closing said drain line;
N. a first force means such as a pump, air pressure, gravitational flow, vacuum, or the like, coupled therein for selectively forcing the flow of developer and fixer solution through said feed lines from said first and second storage reservoirs to said reaction chambers, operable upon selectively opening of said feed line valves;
O. a second force means such as a pump, air pressure, gravitational flow, vacuum, or the like, coupled therein for selectively forcing the return of developer and fixer solutions through said feed lines from said reaction chambers to said first and second storage reservoirs, followed by a closing of said feed line valves;
P. a control means, operable to cause said automated static X-ray film processor to sequentially move through a plurality of processing cycles wherein:
a. a primary operator places one or a plurality of exposed X-ray film and holders in an unused reaction chamber, then operates said control means which opens said associated feed line valve and activates said first force means causing the flow of developer solution into said reaction chamber thereby submerging and bathing said exposed X-ray film in developer solution;
b. a secondary operator commences a secondary cycle wherein one or a plurality of exposed X-ray film and cassettes is placed in a secondary unused reaction chamber while a previous cycle is running in said primary reaction chamber, a start key is pressed on said control means which, as chemicals are available, opens said associated feed line valve and activates said first force means causing developer solution to flow into said secondary reaction chamber, thereby bathing said exposed X-ray film in developer solution;
c. an additional operator commences an n cycle, where n represents the number of reaction chambers above 2, wherein said operator places one or a plurality of exposed X-ray film and holder in one of said n unused reaction chambers while one or a plurality of previous cycles are running in other said reaction chambers, then operates said control means which, as chemicals are available, opens said associated feed line valve and activates said first force means causing developer solution to flow into said n reaction chamber, thereby bathing said exposed X-ray film in developer solution;
d. said processing cycles of each reaction chamber continues individually to completion wherein:
once said X-ray film has been properly developed, said control means operates to activate said second force means and return said developer solution to said first storage reservoir;
said control means operates to close said feed line valve and terminate said second force means, sealing developer solution in said first reservoir;
said control means operates to open said water valve and cause the fill of said reaction chamber with water adjacent to the upper rim and wash out remnant developer solution from said reaction chamber and X-ray film therein;
said control means operates to open said drain valve to remove developer contaminated wash water from said reaction chamber;
said control means operates to close said drain valve;
said control means operates to open said second reservoir feed line valve and activate said first force means which flows fixer into said reaction chamber bathing
said X-ray film in fixer solution;
once said X-ray film is properly fixed, said control means operates to activate said second force means which returns said fixer solution to said second storage reservoir;
said control means operates to close said feed line valve and terminate said second force means, sealing fixer solution in said second reservoir;
said control means operates said water valve to fill said reaction chamber with water and thereby wash out remnant fixer solution from said reaction chamber and X-ray film;
said control means opens said drain valve to remove contaminated wash water from said reaction chamber;
said control means operates to close said drain valve;
said control means operates said blower/heater mechanism to dry said X-ray film;
said operator removes film from said reaction chamber;

2. The device of claim 1 further comprising overflow drain lines fluidly coupled to each said reaction chamber adjacent to said upper rims.

3. The device of claim 1 further comprising a dryer mechanism for each reaction chamber comprising an air blowing device with air heater device configured and disposed to dry said X-ray film in each said reaction chamber once final wash has been completed.

4. The device of claim 1 wherein each said reaction chamber upper rim further comprises a cover plate selectively attachable to said upper rim, said cover plate having an inner surface and an outer surface and being movable between an open position and a closed position whereat said cover member is in abutting contact with said upper rim.

5. The device of claim 1 farther comprising an X-ray film mounting cassette, said film cassette being sized and configured to accept at least one previously exposed X-ray film, and attachable so that said X-ray film resides completely within said reaction chamber in a manner that would completely submerge said X-ray film with chemical flowed therein.

6. A method for processing X-ray film in an automated static X-ray film processor that will allow for the running of additional processing cycles of X-ray film while a previous cycle is running, comprising the steps of:
a primary operator placing one or a plurality of exposed X-ray film and holders in a primary unused reaction chamber, then operating a control means which opens said associated developer feed line valve and activates said first force means causing the flow of developer solution into said reaction chamber, thereby submerging and bathing said exposed X-ray film in developer solution;
a secondary operator wishing to process X-ray film places one or a plurality of exposed X-ray film and holders in a secondary unused reaction chamber while a previous cycle is running in said primary reaction chamber, then operates said control means which, as chemicals are available from said primary cycle, opens said associated feed line valve and activates said first force means causing developer solution to flow into said secondary reaction chamber, thereby bathing said exposed X-ray film and holder in developer solution;
an additional operator wishing to process X-ray film places one or a plurality of exposed X-ray film and holders in one of said n open reaction chambers while previous cycles are running in other said reaction chambers, then operates said control means which, as chemicals are available, opens said associated feed line valve and activates said first force means causing developer solution to flow into said n reaction chamber, thereby bathing said exposed X-ray film in developer solution;
processing cycles of each said reaction chamber continue individually to completion wherein:
once said X-ray film is properly developed, said control means operates to return said developer solution to said first storage reservoir via said second force means;
said control means operates to close said feed line valve and terminate said second force means, sealing developer solution in said first reservoir;
said control means operates to open said water valve to fill said reaction chamber with water adjacent to the upper rim and wash out remnant developer solution from said reaction chamber and X-ray film;
said control means operates to open said drain valve to remove chemically contaminated wash water from said reaction chamber;
once contaminated wash water is drained from said reaction chamber, said control means operates to close said drain line valve;
said control means operates to open said second reservoir feed line valve and activate said first force means causing the flow of fixer into said reaction chamber, bathing said X-ray film in fixer solution;
once X-ray film is properly fixed, said control means operates said second force means which returns said fixer solution to said second storage reservoir;
said control means operates to close said fixer feed line valve and terminate said second force means, sealing fixer solution in said second reservoir;
said control means operates said water valve to fill said reaction chamber with water and thereby wash out remnant fixer solution from said reaction chamber and X-ray film;
said control means opens said drain valve to remove contaminated wash water from said reaction chamber;
once said reaction chamber is drained of wash water, said control means operates to close said drain valve;
said control means operates said heater/blower apparatus to dry said X-ray film;
said operator removes processed X-ray film, making said reaction chamber available for another set of X-ray film to be processed, and a new cycle to be commenced, which may run in overlapped successive cycles with other X-ray film being processed;

7. A kit for processing of dental X-ray film in a dental office, said kit comprising:
packaging materials;
the device of claim 1; and
at least one instructional device for explaining the use of said device.

8. A kit according to claim 7, wherein said instructional device includes at least one device selected from the group consisting of printed materials, CD disks, magnetic data storage disks, and videotapes.
